(19) United States
(12) Patent Application Publication
(10) Pub. No.: US 2014/0305274 A1
(43) Pub. Date: Oct. 16, 2014

(54) INTEGRATED LABEL REMOVER

(71) Applicant: 3M INNOVATIVE PROPERTIES COMPANY, St. Paul, MN (US)

(72) Inventors: Gerald E. Mueller, Eagan, MN (US); Joy A. Packard, Somerset, WI (US); Shaelyn D. Crutchley, St. Paul, MN (US)

(21) Appl. No.: 14/357,394

(22) PCT Filed: Nov. 5, 2012
(86) PCT No.: PCT/US12/63602

§ 371 Date: May 9, 2014

Related U.S. Application Data
(60) Provisional application No. 61/558,724, filed on Nov. 11, 2011.

(51) Int. Cl. B26B 3/08

(52) U.S. Cl. CPC B26B 3/08
USPC 83/861

(57) ABSTRACT

To assist in the reuse and repurposing of packaging and others materials, the present disclosure provides an integrated label remover that allows for quick and easy removal of media (e.g., labels, UPC codes) from a box or other packaging material (e.g., a protective envelope). The label remover utilizes a micro blade to score or cut around the label and a larger lifting blade that allows a user to easily detach the edge of the media for removal. The micro blade can cut to a micro layer thickness while preserving the integrity of the box. This micro layer cut provides access to the area between the media and the material, so that the lifting blade can be inserted to disrupt any adhesive or other means of affixation.

### BACKGROUND

Reuse of packaging materials, including boxes, is a growing consumer desire. E-commerce, including internet shopping, has resulted in a significant increase in the packages received that can be reused or repurposed. The reuse of these materials typically demands removing or hiding old markings, including address labels and shipping barcodes, to avoid incorrect shipments, surface clutter, or information oversaturation. In addition, increased security concerns may necessitate removal or the obscuring of name and address information to prevent unwanted dissemination of personal information.

### SUMMARY

To assist in the reuse and repurposing of packaging and others materials, the present disclosure provides an integrated label remover that allows for quick and easy removal of media (e.g., labels, UPC codes) from a box or other packaging material (e.g., a protective envelope). The label remover utilizes a microblade to score or cut around the label and a larger lifting blade that allows a user to easily detach the edge of the media for removal. The microblade can cut to a micro layer thickness while preserving the integrity of the box. This microlayer cut provides access to the area between the media and the material, so that the lifting blade can be inserted to disrupt any adhesive or other means of affixation.

The present disclosure provides an integrated apparatus for removing media from a surface. The apparatus comprises a body including a housing having a guide surface; a microblade protruding from the body in a direction perpendicular to the major plane of the guide surface; and a lifting blade protruding from the body in a direction generally parallel to the major plane of the guide surface.

The present disclosure also provides a multi-purpose, unitary blade body. The blade includes a lifting blade comprising first and second edges converging to form a lifting tip; and a microblade comprising third and fourth edges converging to the form a microblade tip, wherein the length of at least one of the first and second edges is at least twice the length of the third edge.

The present disclosure further provides a method of removing media from a surface, the method including: providing a label remover including a guide surface, a microblade and a lifting blade; providing a substrate having media affixed thereto, wherein the media includes a periphery; placing the guide surface proximate to the substrate; moving the microblade relative to the substrate, the movement causing the microblade to score a portion of the substrate; inserting the lifting blade between the media and the substrate; and manipulating the label remover to separate at least a portion of the media from the substrate.

As used herein, the term “media” includes, but is not limited to, labels, UPC codes, and other features typically affixed to substrates, particularly packaging materials.

The terms “comprises” and variations thereof do not have a limiting meaning where these terms appear in the description and claims.

The words “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

As recited herein, all numbers should be considered modified by the term “about”.

As used herein, “a,” “an,” “the,” “at least one,” and “one or more” are used interchangeably. Thus, for example, a label remover comprising “a” microblade may be considered to include “one or more” microblades.

Also herein, the recitations of numerical ranges by endpoints include all numbers subsumed within that range (e.g., 1 to 5 includes 1, 1.5, 2, 2.75, 3, 3.80, 4, 5, etc.).

The above summary of the present invention is not intended to describe each disclosed embodiment or every implementation of the present invention. The description that follows more particularly exemplifies illustrative embodiments. In several places throughout the application, guidance is provided through lists of examples, which examples can be used in various combinations. In each instance, the recited list serves only as a representative group and should not be interpreted as an exhaustive list.

### BRIEF DESCRIPTION OF THE DRAWINGS

The invention will be further described with reference to the drawings, wherein corresponding reference characters indicate corresponding parts throughout the several views, and wherein:

FIG. 1 is a perspective view of a label remover according to one embodiment of the present disclosure.

FIG. 2 is a perspective view of an integrated blade according to one embodiment of the present disclosure.

FIG. 3 is a side plan view of the integrated blade of FIG. 2.

FIG. 4 is an exploded perspective view of the label remover of FIG. 1.

FIG. 5 is a side plan view of the label remover of FIG. 1.

FIG. 6 is an enlarged side plan view of the label remover of FIG. 5.

While the above-identified figures set forth several embodiments of the invention, other embodiments are also contemplated, as noted in the discussion. In all cases, this disclosure presents the invention by way of representation and not limitation. It should be understood that numerous other modifications and embodiments can be devised by those skilled in the art, which fall within the scope and spirit of the principles of the invention.

### DETAILED DESCRIPTION OF ILLUSTRATIVE EMBODIMENTS

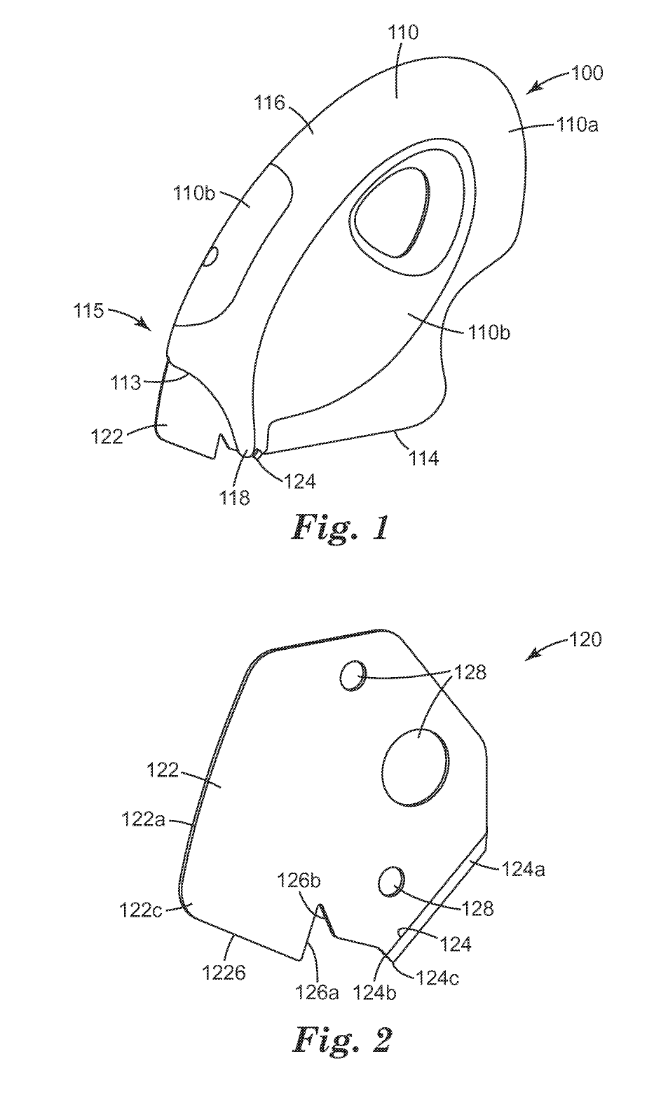

FIG. 1 illustrates an exemplary embodiment of a label remover according to the present disclosure. A label remover 100 includes a body 110, a lifting blade 122, and a microblade 124. In the depicted embodiments, the lifting blade 122 and microblade 124 are part of an integrated, unitary blade structure 120 (See FIG. 2). It should be appreciated, however, that the blades may be distinct structural features. The body 110 can be self-contained and compactly constructed to provide a relatively low profile and small footprint for, among other factors, ease of use and storage. In the embodiment illustrated FIGS. 1 and 4, the body 110 comprises an elongated housing of a polymeric material, typically formed by injection molding. The particular choice of material is not particularly limiting as long as the housing can be manufactured as desired and can function as desired once the tool is assembled. The elongated housing may also be made by metal injection molding, die-casting, forming, machining and the like. For example, the body 110 can be made of thermoplastics such as polypropylene, polybutylene terephthalate, polystyrene, polyethylene, polythermide, polyethylene terephthalate, polystyrene, polyvinyl chloride, polymethylmethacrylate, acrylonitrile-butadiene styrene, polycarbonate, and blends thereof. Other possible materials include ceramics, alloys, and metals, such as aluminum, steel, and stainless steel. The elongated housing may comprise more than one material as shown in FIG. 1; a hard rigid material may be used to form portion 110a of the elongated housing, and a soft typically polymeric material may be used to form portions 110b, as desired, for comfort when the label remover is being gripped and/or used. The elongated housing can further be an ergonomic elongated housing as shown.

The body 110 may include two mating portions 111 and 112 that cooperate to form the elongated housing (see FIG. 4). Alternatively (though not depicted), the body 110 may include a unitary housing. The first and second housing portions 111 and 112 may be secured together by any suitable means including, but not limited to, snap-fit together or coupled by pivots, frictional interference fits, welding, sonic welding, heat-staking, solvent bonding, mechanical fasteners, and the like.

The elongated housing comprises an operative section 115 and a user engageable section 116. As depicted in the Figures, the lifting blade 122 and microblade 124 emerge and protrude from the operative section 115. The operative section includes a leading edge 113 proximate the lifting blade 122. The operative section 115 may also include a protective wall 118 or other protrusion between the microblade 124 and the lifting blade 122.

The body 110 further includes a guide surface 114 on the bottom (as oriented in FIG. 1) of the housing. In the depicted embodiments, the guide surface 114 is substantially planar and includes a curved transition to the sides of the housing. It is also contemplated that the guide surface 114 includes a single radius of curvature. In such an embodiment, a major plane can be defined at the apex of the guide surface 114. In yet other embodiments, the guide surface is a flat surface, having an abrupt transition to the side housing.

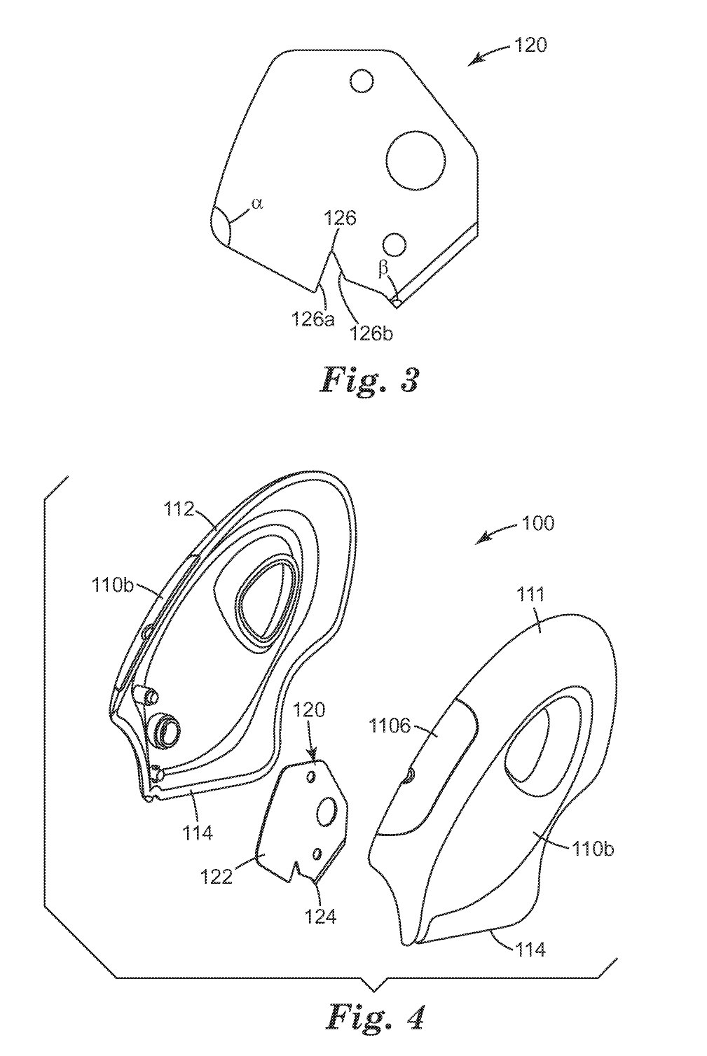

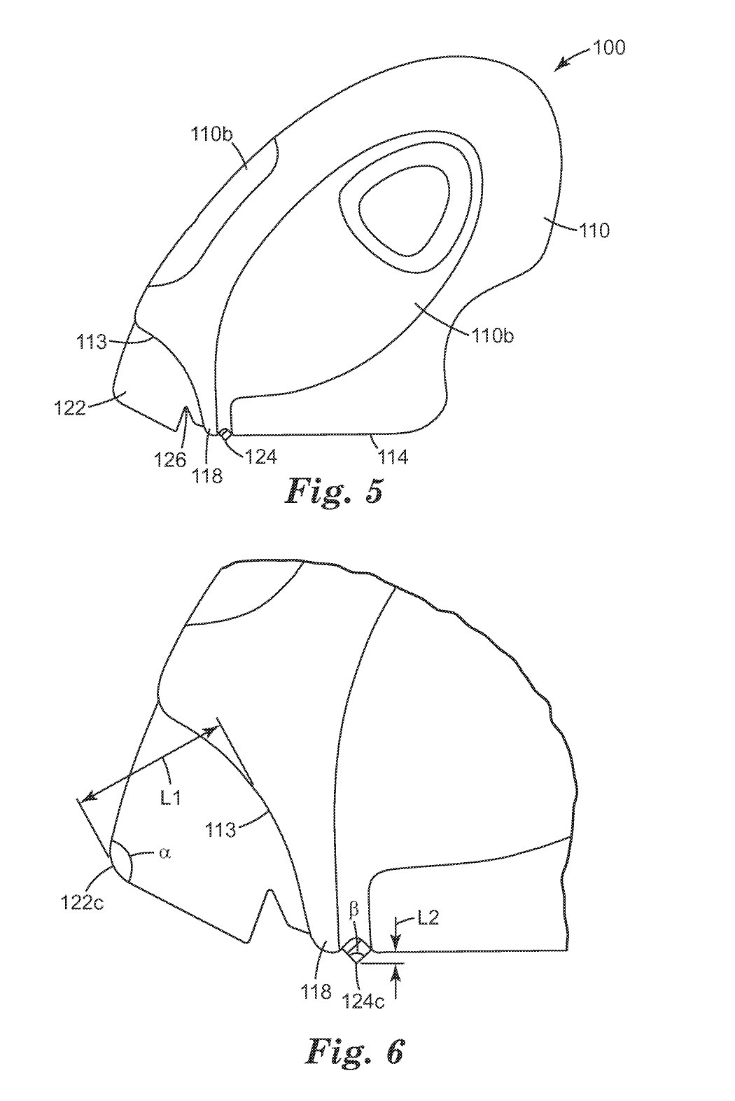

The lifting blade 122 protrudes from the leading edge 113 of the body 110 in a direction generally parallel to the major plane of the guide surface 114. The lifting blade 122 is at least substantially planar and protrudes from the housing such that a lifting tip and two or more edges can be utilized for separating a label or other affixed media from a surface. The visible portion of the lifting blade 122 that protrudes from the housing cooperates with the leading edge 113 to define a planar lifting area. As shown in FIGS. 2 and 3, the lifting blade 122 comprises two exposed edges 122a, 122b which converge to form a lifting tip 122c. The exposed edges 122a and 122b may be joined by a curved section of the lifting blade, such that the lifting tip includes a radius of curvature. In other embodiments, the exposed edges converge to form a pointed tip.

Referring to FIGS. 3 and 6, the lifting blade can be characterized as having an angle, α, formed by the edges that define the lifting tip. The lifting angle a can be any useful angle as long as the label remover can function as desired, though the angle is preferably greater than 45 degrees in certain circumstances. For example, the lifting angle may be within a particular range of angles such that the tip can be forced under a portion of a label or other affixed media. For example, the blade angle can be from 40 to 150 degrees or from 60 to 120 degrees.

Referring to FIG. 6, the distance from the leading edge 113 of the body to the lifting tip 122c defines a length, L1, and this distance is preferably long enough that the lifting blade comprises sufficient surface area to dislodge a portion of a label from packaging material after the lifting blade is placed thereunder. The distance from the leading edge 113 to lifting tip 125c can be any useful length, for example, at least 0.1 inches, in other embodiments at least 0.25 inches, in other embodiments at least 0.5 inches. The distance L1 may be no greater than 2 inches, in some embodiments no greater than 1.0 inch, in some embodiments no greater than 0.75 inches, and in other embodiments no greater than 0.6 inches.

The lifting blade 122 typically comprises a thickness that is less than that of the operative section 115 of the elongated housing. In some embodiments, the thickness of the lifting blade is no greater than 0.030 inches, in some embodiments no greater than 0.20 inches, and in some embodiments no greater than 0.15 inches. In certain embodiments, the thickness of the lifting blade is at least 0.05 inches, and in some embodiments at least 0.10 inches.

The lifting blade may be made from a wide variety of suitable materials, including ceramics, polymers, metals, and alloys. In certain preferred circumstances, the lifting blade comprises stainless steel. In other embodiments, the lifting blade may be formed integrally with the body, such that the lifting blade is simply a thinner portion of the operative section of the elongated housing.

The microblade 124 partially protrudes from and is generally perpendicular to the major plane of the guide surface 114. The visible portion of the microblade 124 that protrudes from the housing defines a planar cutting area. In certain embodiments, the lifting area is at least twice the size of the cutting area. In other embodiments, the lifting area is at least 3 times as large as the cutting area. Typically, the cutting area resides on the same plane as the lifting area of the lifting blade. As shown in FIG. 2, microblade 124 comprises cutting edge 124a, and trailing edge 124b which can comprise a second cutting edge, and blade tip 124c formed by the edges. In certain embodiments, the cutting edge 124a is beveled or comprises a thickness less than the thickness of the lifting blade 122. In other embodiments, both the cutting edge 124a and the trailing edge 124b are beveled. In yet other embodiments, neither the cutting edge 124a nor the trailing edge 124a are beveled or otherwise thinner than the lifting blade 122.

In the depicted embodiments, the microblade 124 is located proximate the leading edge 113 of the body. It can be desirable to locate the blade proximate the leading edge 113, as such placement may provide for greater control of the cutting depth. In other envisioned embodiments, the microblade 124 can be located remote from the leading edge 113, protruding from any surface of the housing. The microblade may also comprise a stylus or other structure capable of creating a microabrasion in packaging material. Like the lifting blade, the microblade may be made from a wide variety of known materials, including ceramics, polymers, alloys, and metals.

The cutting area of the microblade 124 and its relationship to the substantially planar surface of the guide surface of the body enable a user to precisely score or otherwise cut packaging material with ease relative to known hand tools designed for removing affixed media. Furthermore, controlling this relationship can help minimize the risk of injury while handling or storing the label remover. Referring to FIG. 6, the distance from guide surface 114 to microblade tip 124c defines a length, L2, and this distance is preferably long enough such that packaging material proximate the affixed media can be cut and short enough such that little or no portion of the cutting area extends through the thickness of the material or otherwise renders the packaging material unsuitable for reuse. The distance from guide edge 114 to microblade tip 124c can be any useful length, for example, at least 0.010 inches, in other embodiments at least 0.015 inches, in other embodiments at least 0.02 inches. The distance L2 may be no greater than 0.1 inches, some embodiments no greater than 0.08 inches, in some embodiments no greater than 0.06 inches, and in other embodiments no greater than 0.04 inches. In certain implementations, the distance L2 is 0.030 inches.

Referring again to FIGS. 3 and 6, the cutting area of the blade can be characterized as having a blade angle, β, formed by the edges that define the microblade tip 125c. The blade angle β can be any useful angle as long as the label remover can function as desired. For example, the blade angle may be within a particular range of angles such that the blade tip can facilitate penetration of the blade into the packaging material. For example, the blade angle β can be from 20 to 120 degrees or from 80 to 100 degrees.

Though depicted as part of a unitary body, the microblade 124 may also be provided as part of a cartridge system. The cartridge system includes a blade cartridge releasably secured in the housing and a plurality of microblades stored in the blade cartridge. The cartridge system allows for replacement of the microblade and extends life of the label remover.

The lifting blade 122 may optionally include a recess 126 to facilitate the opening of packages, as further described below. The recess 126 is at least partially defined by splitting edges 126a and 126b. Typically, the two splitting edges 126a, 126b converge to a point. In other embodiments, the splitting edges may be joined by a curved section of the lifting blade. The splitting edge 126a typically extends in a direction generally perpendicular to lifting edge 122a, but other directions of extension are also contemplated.

Referring again to FIGS. 2 and 3, the lifting blade and the microblade may be part of the same unitary blade body 120. Typically, at least a portion of this unitary blade 120 is enclosed in the housing. The enclosed portion may be secured within the housing by any means known in the art, including but not limited to adhesives, fasteners, interference-fits, and the like. For example, the unitary blade 120 may include a plurality of apertures 128 that can be coupled to mating posts on an interior surface of the body.

As depicted, the unitary blade body is at least substantially planar and includes at least four major edges, not including the cutting edge and trailing edge. Other shapes are also contemplated, so long as the lifting blade tip 122 and the lifting area are spaced a certain distance from the microblade tip 124c and the lifting area defined by edges 122a and 122b is greater in size than the cutting area of the microblade 124. In certain embodiments, the lifting area is at least twice the size of the cutting area. In other embodiments, the lifting area is at least 3 times as large as the cutting area.

The thickness of the unitary blade body 120 is typically no greater than 0.030 inches, in some embodiments no greater than 0.20 inches, and in some embodiments no greater than 0.15 inches. In certain embodiments, the thickness of the unitary blade body, excluding the cutting edge 124a, is not less than 0.05 inches, and in some embodiments not less than 0.10 inches. The unitary blade body 120 may be made from a wide variety of suitable material, including ceramics, polymers, metals, and alloys. In certain preferred embodiments, the unitary blade 120 comprises stainless steel.

The present disclosure also provides for methods of removing media from substrates, particular those used in packaging. Though the methods are capable of being performed with any of the label remover embodiments described above, the methods will be described using the label remover 100. In one implementation, the label remover 100 is oriented such that the guide surface 114 is substantially parallel with a substrate e.g., a packaging material surface. It may be preferred to orient the label remover so that the microblade is perpendicular to the packaging material surface. However, the label remover can be rotated about the guide surface so that an angle formed between the cutting face of the blade 124 and the material is at least 60 degrees, at least 70, and preferably at least 80 degrees.

The microblade is then placed near the periphery of the media to be removed and the cutting edge 124a is drawn across some portion of the packaging material surface. It is also contemplated that the label remover is pushed in direction away from the user, so that the trailing edge 124b of the microblade 124 scores the packaging material. In other embodiments, the cutting edge 124a of the microblade 124 is drawn or pushed across a portion of the media itself. The microblade 124 may score along at least a portion of the periphery of the media, though in some circumstances it may be desirable to cut along the entire periphery.

After the desired amount of substrate has been scored, the label remover may be rotated such that the lifting area is substantially parallel with the substrate. The lifting blade tip 122c, as well as at least a portion of the lifting area, may be inserted between the substrate and the media. Once inserted, the label remover may be pivoted against the substrate or drawn upward, detaching a portion of the media from the substrate. This detached portion can be used as a peeling edge to completely remove the media from the surface. In other embodiments, the lifting blade 122 may be used to scratch off or otherwise abrade the media intended to be removed.

In embodiments including a lifting blade with a recess, a splitting edge may be used to cut labels or tape secured over an opening in the packaging material. For example, a section of tape may be used to secure the lid of a box to the box body. The splitting edge may be placed proximate to the tape at an area where the lid section meets the body. The label remover may then be drawn across the tape, allowing the splitting edge to cut a portion of the tape. Alternatively, this opening function may be performed by the microblade.

### EMBODIMENTS

1. An apparatus for removing media from a surface, the apparatus comprising:

a body including a housing having a guide surface;

a microblade protruding from the body in a direction perpendicular to the major plane of the guide surface; and

a lifting blade protruding from the body in a direction generally parallel to the major plane of the guide surface.

2. The apparatus of embodiment 1, wherein the elongated housing comprises an operative section and a user engageable section.
3. The apparatus of embodiment 2, wherein the microblade and the lifting blade protrude from the operative section of the body.
4. The apparatus of embodiments 2 or 3, wherein the operative section comprises a leading edge, and wherein the lifting blade protrudes from the leading edge.
5. The apparatus of any of the preceding embodiments, wherein the microblade and the lifting blade are part of a unitary blade body.
6. The apparatus of embodiment 5, wherein a portion of the unitary blade body is enclosed within the housing.
7. The apparatus of any of the preceding embodiments, wherein the lifting blade comprises a greater surface area than the microblade.
8. The apparatus of any of the preceding embodiments, wherein the microblade protrudes a certain distance below the guide surface of at least 0.015 inches and no greater than 0.08 inches.
9. The apparatus of any of the preceding embodiments, wherein the lifting blade comprises a pair of lifting edges, said lifting edges converging to form a lifting tip.
10. The apparatus of embodiment 9, wherein the lifting tip is rounded.
11. The apparatus of any of the preceding embodiments, wherein the lifting blade comprises a recess distal to the lifting tip.
12. The apparatus of embodiment 11, wherein the lifting blade comprises a lifting edge, and wherein the recess comprises splitting edge that extends in a direction substantially parallel to the lifting edge.
13. The apparatus of any of the preceding embodiments, wherein the microblade comprises a blade angle between 40 degrees and 120 degrees.
14. The apparatus of any of the preceding embodiments, wherein the microblade comprises at least one beveled cutting edge.
15. The apparatus of embodiment 1, wherein the lifting blade is integral with and includes the same material as the housing.
16. A unitary blade body including: a lifting blade comprising first and second edges converging to form a lifting tip; and a microblade comprising third and fourth edges converging to the form a blade tip, wherein the length of at least one of the first and second edges is at least twice the length of the third edge.
17. The unitary body of embodiment 16, wherein the lifting blade and the microblade each comprise a blade angle, and wherein the blade angle of the lifting blade is greater than the blade angle of the microblade.
18. The unitary blade body of embodiments 16 or 17 and further comprising a recess between the lifting blade and the microblade.
19. The unitary blade body of any of the preceding embodiments, wherein the microblade comprises at least one beveled cutting edge.
21. The unitary blade of any of the preceding embodiments, wherein the thickness of the unitary body is no greater than 0.030 inches.
22. A method of removing media from a surface, the method comprising: providing the label remover including a guide surface, a microblade and a lifting blade; providing a substrate having media affixed thereto, wherein the media includes a periphery; placing the guide surface proximate to the substrate; moving the microblade relative to the substrate, the movement causing the microblade to score a portion of the substrate; inserting the lifting blade between the media and the substrate; lifting the label remover to separate at least a portion of the media from the substrate.
23. The method of embodiment 22, wherein the microblade and the lifting blade are part of a unitary blade body.
24. The method of embodiments 22 or 23 and further comprising removing at least a portion of the media from the substrate.
25. The method of any of the previous embodiments and further comprising rotating the label remover prior to inserting the lifting blade.

Various modifications and alterations to this invention will become apparent to those skilled in the art without departing from the scope and spirit of this invention. It should be understood that this invention is not intended to be unduly limited by the illustrative embodiments and examples set forth herein and that such examples and embodiments are presented by way of example only with the scope of the invention intended to be limited only by the embodiments set forth herein as follows.

1. An apparatus for removing media from a surface, the apparatus comprising:
a body including a housing having a guide surface;
a microblade protruding from the body and below the major plane of the guide surface in a direction perpendicular to the major plane of the guide surface; and
a lifting blade protruding from the body in a direction generally parallel to the major plane of the guide surface.

2. The apparatus of claim 1, wherein the elongated housing comprises an operative section and a user engageable section.

3. The apparatus of claim 2, wherein the microblade and the lifting blade protrude from the operative section of the body.

4. The apparatus of claim 2, wherein the operative section comprises a leading edge, and wherein the lifting blade protrudes from the leading edge.

5. The apparatus of claim 1, wherein the microblade and the lifting blade are part of a unitary blade body.

6. The apparatus of claim 5, wherein a portion of the unitary blade body is enclosed within the housing.

7. The apparatus of claim 1, wherein the lifting blade comprises a greater surface area than the microblade.

8. The apparatus of claim 1, wherein the microblade protrudes a certain distance below the guide surface of at least 0.015 inches and no greater than 0.08 inches.

9. The apparatus of claim 1, wherein the lifting blade comprises a pair of lifting edges, said lifting edges converging to form a lifting tip.

10. The apparatus of claim 9, wherein the lifting tip is rounded.

11. The apparatus of claim 1, wherein the lifting blade comprises a recess distal to the lifting tip.

12. The apparatus of claim 11, wherein the lifting blade comprises a lifting edge, and wherein the recess comprises splitting edge that extends in a direction substantially parallel to the lifting edge.

13. The apparatus of claim 1, wherein the microblade comprises a blade angle between 40 degrees and 120 degrees.

14. The apparatus of claim 1, wherein the microblade comprises at least one beveled cutting edge.

15. The apparatus of claim 1, wherein the lifting blade is integral with and includes the same material as the housing.

16. A unitary blade body comprising:
a lifting blade comprising first and second edges converging to form a lifting tip; and a microblade comprising third and fourth edges converging to the form a blade tip, wherein the length of at least one of the first and second edges is at least twice the length of the third edge.

17. The unitary body of claim 16, wherein the lifting blade and the microblade each comprise a blade angle, and wherein the blade angle of the lifting blade is greater than the blade angle of the microblade.

18. The unitary blade body of claim 16 and further comprising a recess between the lifting blade and the microblade.

19. The unitary blade body of claim 18, wherein the microblade comprises at least one beveled cutting edge.

20. The unitary blade of claim 18, wherein the thickness of the unitary body is no greater than 0.030 inches.

21. A method of removing media from a surface, the method comprising:
providing the label remover including a guide surface, a microblade and a lifting blade;
providing a substrate having media affixed thereto, wherein the media includes a periphery;
placing the guide surface proximate to the substrate;
moving the microblade relative to the substrate, the movement causing the microblade to score a portion of the substrate;
inserting the lifting blade between the media and the substrate;
lifting the label remover to separate at least a portion of the media from the substrate.

22. The method of claim 21, wherein the microblade and the lifting blade are part of a unitary blade body.

23. The method of claim 21 and further comprising removing at least a portion of the media from the substrate.

24. The method of claim 21 and further comprising rotating the label remover prior to inserting the lifting blade.
